(19) United States
(12) Patent Application Publication
(10) Pub. No.: US 2014/0299260 A1
(43) Pub. Date: Oct. 9, 2014

(54) Method for Producing an Endless Semi-Finished Product with at least an Inclined Reinforced Layer

(71) Applicant: F.A. Kümpers GmbH & Co. KG, Rheine (DE)

(72) Inventors: Rudolf Bonse, Munster (DE); Joan-Dirk Kümpers, Rheine (DE)

(73) Assignee: F.A. Kümpers GmbH & Co. KG, Rheine (DE)

(21) Appl. No.: 14/225,684

(22) Filed: Mar. 26, 2014

(30) Foreign Application Priority Data
Mar. 26, 2013 (DE) 10 2013 103 049.1

(51) Int. Cl. B32B 37/24

(52) U.S. Cl. CPC B32B 37/24
USPC 156/181

(57) ABSTRACT

The invention refers to a method for manufacturing a continuous semi-finished product (HZ) to produce machined parts, whereby the semi-finished product (HZ) has at least one obliquely reinforced layer (SVS) that has a polymer matrix and reinforcing fibers (VF) embedded therein, in which case the reinforcing fibers (VS) of the at least one obliquely reinforced layer (SVS) run obliquely to the longitudinal direction (LR) of the semi-finished product (HZ), in which case the at least one obliquely reinforced layer (SVS) is continuously manufactured through the following steps:
a) Supplying numerous reinforcing fibers (VF) in their longitudinal direction to a hose former (4) by means of a feeding device (2),
b) Forming the supplied reinforcing fibers (VF) to a hose (S) by means of the hose former (3), in such a way that the reinforcing fibers (VF) run in longitudinal direction of the hose (S),
c) Solidifying the hose (S) that contains the reinforcing fibers (VF) in its circumferential direction by means of a solidification machine (4), in a way to stabilize the form of the hose (S),
d) Cutting up the stabilized hose (S) containing the reinforcing fibers (VS) with a hose-cutting machine (5) in such a way that at least one endless cut (ES) is generated obliquely to the circumferential direction of the hose (S), so that the obliquely reinforced layer (SVS) is continuously supplied.

The invention also refers to a corresponding device (1).

The invention refers to a method for manufacturing a continuous semi-finished product for making machined parts, whereby the semi-finished product has at least one obliquely reinforced layer with a polymer matrix and reinforcing fibers embedded therein, in which case the reinforcing fibers of the at least one obliquely reinforced layer run obliquely to the longitudinal direction of the semi-finished product.

A machined part is a workpiece that remains in a structural form given to it by the fabrication process after its completion. In this context, semi-finished products for the manufacturing of machined parts are intermediate products that—by themselves or in combination with other semi-finished products—are loaded onto a form tool such as a press, for example, to be formed and undergo final solidification, so that the semi-finished product(s) take the form given by the form tool. The term “continuous” as it is used here means that the method for manufacturing the semi-finished product has been designed in such a way that the semi-finished product can, in principle, reach an infinite length in longitudinal direction so the semi-finished product can be manufactured quickly and economically. The initially continuous semi-finished product can then be disassembled into convenient pieces when the machined parts are manufactured.

In a known method for manufacturing machined parts, semi-finished products containing both a polymer matrix and reinforcing fibers are manufactured first. In this case, the reinforcing fibers have a higher specific tensile strength than the polymer matrix.

The mutual interactions of the polymer matrix and the reinforcing fibers produce a machined part whose mechanical properties are superior to those of the two components. The result is an especially good strength and weight relationship.

Since reinforcing fibers are above all characterized by being able to absorb high tensile forces, it is especially important in many cases for the reinforcing fibers to have a defined orientation in the semi-finished product. So that machined parts with tensile stability can be manufactured in various directions, the semi-finished product often has several layers, in which the reinforcing fibers have different orientations. Here, it is often advantageous for the layer(s) to have in each case reinforcing fibers aligned in parallel. Such a layer also receives the name of unidirectionally reinforced layer. In this context, a distinction is made between longitudinally reinforced layers (or 0° layers), in which the reinforcing fibers run parallel to the longitudinal direction of the semi-finished product, and obliquely reinforced layers (or X° layers), in which the reinforcing fibers run transversally to the longitudinal direction of the semi-finished product, in which case X indicates the value of the angle under which the reinforcing fibers cut the longitudinal direction. Here, X is unequal to zero.

Whereas the manufacturing of continuous longitudinally reinforced layers can take place relatively easy by pulling off, matching and stabilizing the reinforced fibers from a feeding device, the manufacturing of obliquely reinforced fibers is still problematic. Thus, it is known from the manufacturing of an obliquely reinforced layer that the segments individually cut into lengths with an oscillating gripper are deposited transversally into the longitudinal direction of a running base and then the individual segments are stabilized jointly. Even if the movement of the gripper and running base are carefully synchronized, the obliquely reinforced layer manufactured in this way has undesired inhomogeneous sections, especially in the transitions of the individual segments, with regard to the distribution of the reinforcing fibers. In addition, the working speed in such a process is strongly limited because the gripper's oscillating motion is necessarily greater than the width of the layer and the layer's longitudinal yield to be achieved is limited by the width of the segments.

The task of the invention is to improve a method for manufacturing a continuous semi-finished product for manufacturing machined parts.

In a method of the kind described initially, the task is solved in such a way that the at least one obliquely reinforced layer is manufactured continuously with the following steps:

a) Using a feeding device to supply many reinforced fibers longitudinally into a hose former,
b) Forming the supplied reinforced fibers to a hose using the hose former in such a way that the reinforcement fibers run in the longitudinal direction of the hose,
c) Solidifying the hose containing the reinforced fibers in its circumferential direction with a solidification machine in a way to stabilize the form of the hose.
d) Cutting up the stabilized hose containing the reinforced fibers with a hose-cutting machine so that at least one continuous cut is made transversally to the hose's circumferential direction so the obliquely reinforced layer is continuously supplied.

In step a), a feeding device guides a large number of reinforcing fibers in their longitudinal direction to a hose former. In this case, the feeding device can supply the large number of reinforcing fibers in their longitudinal direction in a continuous form. To do this, it can use passive mechanical fiber handling aids such as combs, thread guides, guide channels and the like, as well as active mechanical fiber handling machines such as feed rollers, spindles and the like, and/or pneumatic fiber handling media such as suction devices, blowing devices and the like.

In step b), the supplied reinforcing fibers are formed to a hose by means of the hose former so that the reinforcing fibers run in the longitudinal direction of the hose. Here, a hose is understood to be a hollow cylindrical structure made up of arranged reinforcing fibers. Preferably, the hose has a circular cross section because this is how an especially uniform density of the reinforcing fibers can be achieved in circumferential direction. For this purpose, the hose former can also comprise mechanical handling aids such as thread guides, guide channels and the like, as well as active mechanical handling machines such as feed rollers, spindles and the like, and/or pneumatic handling media such as suction devices, blowing devices and the like.

The hose is transported or advanced in the entire system by means of known conveyors. For example, transportation takes place by belt drives that engage on the inner perimeter of the hose and can be especially arranged in the hose former. Several such belt drives, displaced behind one another, can be provided. Alternatively or additionally, the use of known hose pull-off systems is also possible.

Now, in step c), the hose containing the reinforcing fibers is solidified in its circumferential direction with a solidification machine to stabilize its tubular form.

Here, the solidification takes place in step d) in such a way that the stabilized hose containing the reinforcing fibers can be cut in such a way with a hose-cutting machine that at least one endless cut is made obliquely to the hose's circumferential direction, so that the obliquely reinforced layer is supplied uninterruptedly. Here, obliquely to the circumferential direction means that the cut is made under an angle unequal to zero compared to the circumferential direction, for example at an angle of 45°. In principle, all slanted angles compared to the circumferential direction are possible. Changes in the cut's inclination along the longitudinal direction of the hose are by all means possible too. Preferred are endless cuts at an angle from 10° to 80°, even more preferred those within the 30° to 60° angle range (45° for example).

The term “endless cut” means that the hose is not cut along its circumferential direction into individual pieces, but continuously while being transported longitudinally so that one single continuous, elongated semi-finished product can be obtained as long as the hose is being fed into the cutting unit.

In this process, the endless cut can be made through mechanical cutting, a laser, a jet of water or air, for example, or with another method. Here, the endless cut can be made with a rotating cutting unit moving in circumferential direction with respect to the hose, in which case a helical-shaped cut is obtained through the superposition of the rotational movement of the cutting device and the movement of the hose in its longitudinal direction. This results in a continuous layer of a semi-finished product, in which the reinforcing fibers run obliquely to the longitudinal direction of the semi-finished product. The angle under which the reinforcing fibers run with respect to the layer's longitudinal direction is obtained from the angle of inclination of the helical cut. In this case, the following applies: The smaller the angle of inclination, the larger will be the angle under which the reinforcing fibers run with respect to the layer's longitudinal direction.

The method according to the invention allows the uninterrupted manufacturing of a continuous semi-finished product with an obliquely reinforced layer which has a homogeneous distribution and a parallel alignment of the reinforcing fibers. A high working speed is therefore possible because no components are needed that must execute an oscillatory (i.e. changing) movement.

In accordance with a preferred further improvement of the invention, steps a), b), c), & d) are carried out while reinforcing fibers are continuously moving. This means that the reinforcing fibers are guided continuously and uninterruptedly from one step to the next while the process is being executed. While doing so, the speed at which the reinforcing fibers are moving in each one of steps a), b), c), and d) is at least roughly the same in order to prevent an accumulation of materials or an undesired delay in reinforcing fibers. This method prevents a costly Interim storage of the reinforcing fibers and the semi-finished product can be manufactured very quickly.

According to a preferred further improvement of the invention, the solidification in step c) is carried out by gluing the reinforcing fibers, fusing the reinforcing fibers, wetting the reinforcing fibers, gassing the reinforcing fibers, sewing up the reinforcing fibers and/or applying a reinforcing, especially textile, layer.

Gluing can take place by cold bonding, in which an adhesive produces a firm, adhesive bond at room temperature between the reinforcing fibers, and/or by hot bonding, in which an adhesive is heated and produces a firm, adhesive bond between the reinforcing fibers after cooling.

As long as the reinforcing fibers are suitable for welding, the solidification can also be achieved through welding, in which case the reinforcing fibers are heated up at least partially until the liquefaction limit and are firmly bonded against one another when they set.

Likewise, the solidification can also take place by wetting the reinforcing fibers when liquid is applied on them. It is possible for example, to liquefy (at least partially) an avivage finishing adhering to one of the reinforcing fibers with a suitable liquid to achieve a bonding of the reinforcing fibers during subsequent drying of the avivage.

Furthermore, the solidification can take place through gassing the reinforcing fibers by applying a suitable gas on them. In this way, it is also possible to liquefy an avivage finishing adhering to one of the reinforcing fibers with a suitable gas, at least partially, to achieve a bonding of the reinforcing fibers during subsequent solidification.

The solidification can also be achieved by sewing up, which means that the reinforcing fibers are held together by a thread.

Apart from that, the solidification can also take place by applying a reinforcing layer, particularly a textile one.

According to an appropriate further improvement of the invention, the reinforcing fibers supplied comprise glass fibers, carbon fibers and/or aramid fibers. Such materials comply with the requirements made to reinforcing fibers, particularly regarding their strength, and they are also economical and easily processed. However, other high-module fibers are possible.

According to an appropriate further improvement of the invention, the supplied reinforcing fibers are deeply mixed with thermoplastic matrix fibers or enveloped by thermoplastic matrix fibers to make a layer of a semi-finished product, which contains both the reinforcing fibers and the polymer matrix in form of thermoplastic matrix fibers. This facilitates the process because the polymer matrix does not have to be incorporated later. The subsequent manufacturing of the machined part can then take place easily in such a way that the semi-finished product is heated up in a forming device until the thermoplastic matrix fibers melt, so that the semi-finished product can be exactly adapted to the forming device and solidifies after cooling off so the finished machined part is obtained.

A deep mixing of various kinds of fibers is understood to be a mixture characterized by a largely homogenous mixture at the individual fiber level. This means that the various kinds of fibers are mixed in such a way that there are, by and large, no longer groupings of exclusively identical fibers. By using deep mixtures or reinforcing fibers enveloped by thermoplastic matrix fibers, it is ensured that the thermoplastic matrix fibers and the reinforcing fibers are mixed thoroughly in the semi-finished product. In this way, it is possible to achieve the full wetting of the reinforcing fibers when the thermoplastic matrix fibers are melted on top, so that in the subsequent machined part the interactions between thermoplastic matrix and reinforcing fibers are maximized by an improved firm bond. The result is a low-weight machined part capable of withstanding high mechanical stresses.

According to an appropriate further improvement of the invention, the thermo-plastic matrix fibers are polyurethane fibers (especially fibers made of PU), polyamide fibers (especially fibers made of PA), polyether ketone fibers (especially fibers made of PAEK and of its derivatives, particularly PEEK, PEK, PEEEK, PEEKEK, & PEKK), polypropylene fibers (especially fibers made of PP), acrylonitrile-butadiene-styrene fibers (especially fibers made of ABS) and/or polyester fibers (especially fibers made of PES and of its derivatives, particularly PBT, PC, PET, & PEN). Such materials comply especially with the demands made to them regarding their strength, are economical and easily processed.

According to an appropriate further improvement of the invention, the supplied reinforcing fibers include twisted staple fibers. Machined parts that contain reinforcing fibers in form of twisted staple fibers have higher strength transversally to the main direction of the reinforcing fibers than those made by a machine that have reinforcing fibers in form of continuous fibers, also known as filaments. In particular, the holding together of the individual layers can be improved especially in multilayered machined parts.

Moreover, hybrid yarns with staple fibers have a lower proportion of hollow space than hybrid yarns with continuous fibers, thus lowering the risk of undesired air entrapments while forming the machined part (i.e. during consolidation of the textile surface structure). The strength of the machined part is improved in this way.

Furthermore, semi-finished products made from staple fibers can be more easily draped than their pendants made from filaments. As a result of this, the wrinkle-free insertion of the textile surface structure into the forming tool is facilitated. At the same time, this reduces the risk of damaging the structure of the semi-finished product. In this way, it is possible to lower the manufacturing costs of the machined part. Additionally, this allows machined parts having complex shapes to be made from semi-finished products because the latter allow themselves to be more easily laid onto the contour of the forming tool.

Furthermore, the use of staple fibers lowers the risk of fiber buckling during further processing, especially during draping. This, in turn, is advantageous for the strength of the later machined part.

According to an appropriate further improvement of the invention, the supplied reinforcing fibers include continuous fibers. The machined parts containing reinforcing fibers in form of continuous fibers are stronger along the main direction of the reinforcing fibers than those machined parts manufactured with reinforcing parts in form of twisted staple fibers. If the reinforcing fibers are now arranged so that their longitudinal direction corresponds, at least in sections, to a main direction of stress of the later machined part, then the latter will be better able to withstand mechanical stresses. This method can improve the relationship mechanical ability to withstand stress and weight of the machined part.

According to an appropriate further improvement of the invention, the supplied reinforcing fibers are at least shaped to resemble a longitudinally strengthened preformed textile material. A longitudinally strengthened flat textile material is understood to be a structure having reinforcing fibers that run in the longitudinal direction of the structure and are joined to one another transversally to it. In this case, the hose can be formed in such a way that the flat textile material is folded over on one or two sides so that the lateral edges of the flat textile material are brought together. The solidification of the hose can in this case be limited to the area of the edges brought together. To obtain a uniform wall thickness of the hose, the two edges can be brought together without overlapping and joined together in step c). However, it is also conceivable for the flat textile material to be thinner along its edges than in its middle section. Here, an overlapping of the edges can be provided to facilitate the joining of the edges in step c). For example, the edges can be joined through spreading and doubling (i.e. laying on top of one another).

According to an appropriate further improvement, an overlapping of several webs of reinforcing fibers running beside one another, provided as several webs of textile material, for example, are constantly set before or during hose-forming in the longitudinal direction of the hose. In this case, it is also preferable for the hose thickness to remain largely constant over the hose circumference. This can be accomplished, for example, by laying a textile material web with 50% overlapping on or under a neighboring textile material web. In such an arrangement, two textile material webs always meet edge to edge, while an additional textile material web is located over or under these two textile material webs. The thickness of such a hose is therefore always created by two textile material webs lying on top of one another.

According to an appropriate further improvement of the invention, the reinforcing fibers are supplied in form of discrete yarns. In this way, the reinforcing fibers in step c), although solidified on the entire circumference of the hose, can prevent uneven spots in the area of the edges that were brought together in a hose formed by a flat textile structure, something that improves the uniformity of the polymer matrix and/or the reinforcing fibers in the subsequent semi-finished part.

According to an appropriate further improvement of the invention, following step d), the obliquely reinforced layer is wind up by means of a winding device so the semi-finished product can be easily stored and transported.

According to an advantageous further improvement of the invention, a semi-finished product is manufactured with variable thickness. Such semi-finished products can greatly simplify production processes (for example, when building car bodies) since time-consuming cutting processes for cutting the semi-finished product to the desired shape can be reduced or eliminated entirely.

According to an embodiment of the invention, such a width variance can be obtained in by feeding the hose with different diameters along its longitudinal direction to the hose-cutting machine. By cutting up a hose with changing diameters or a changing circumference, a semi-finished product with width variance is obtained through the oblique endless cut.

A related advantageous embodiment ensures that the various diameters are preserved by feeding the reinforcing fibers in their entire width, embedded in a polymer matrix, for example, to the hose former along the longitudinal direction mentioned in their various widths. As a result of this, correspondingly different hose diameters are obtained—with steady overlapping of the edges of the polymer matrix over the course of hose forming—owing to the fact that the polymer matrix sections have different widths. The slanted cutting up will then supply the desired width variance of the resulting semi-finished product.

In an alternative embodiment, which can by all means be combined with the one mentioned above, the different diameters of the hose are obtained by placing a known blowing device (for example, after forming of the hose but before its solidification) that acts against the inner surface of the formed hose. Through this, a hose with different diameters along its course or longitudinal extension is subsequently solidified. Through the oblique endless cut, in turn, a semi-finished product with variable widths is obtained. Alternately or additionally to a blowing device, a negative pressure device can be used for such hose-forming with which a hose section with smaller diameter can be made by compression in radial direction. The use of a ring former for manufacturing a hose with varying diameter in longitudinal direction is also known.

According to another alternative, before the hose is formed, additional reinforcing fibers can be temporarily fed (i.e. with defined lengths) with the help of one or several additional creels from one or two sides. Thermoplastic back cloths can be used here, as is already known. The use of transportation devices, with which a temporary (i.e. interrupted) supply of reinforcing fibers can be achieved, is also possible.

Another alternative foresees, for example, that the reinforcing fibers are embedded in a polymer matrix, fed in the direction of the hose former in uniform width but cut in one or two edges before entering the hose former. This results in a polymer matrix of varying width.

According to another advantageous, alternative method for manufacturing a semi-finished product with variable width, the at least one step used obliquely to the circumferential direction of the hose is applied with different angles of inclination. Among other things, this variant has the advantage that it can be made relatively easy with a machine. For example, by slowing down or accelerating the hose when feeding it into the hose-cutting machine—with an unchanging operating cutting unit—a variable angle of inclination is obtained that leads to a semi-finished product with variable width. Alternatively or additionally, the cutting unit, if rotationally designed, can be rotated with different rotational speed, and this also leads to a variable angle of inclination.

Various combinations of the semi-finished, variable width product manufacturing possibilities mentioned above can by all means be realized. In particular, the most varied geometries of the semi-finished product can be created by adjusting the diameters, the changes of diameters and the angle of inclination of the cut.

Also, instead of a polymer matrix with embedded reinforcing fibers, discrete yarns can be fed to the hose former, in which case the discrete yarns also allow the above-mentioned possibilities for manufacturing a semi-finished product with variable width.

According to an appropriate further improvement of the invention, after step d), the continuously supplied obliquely reinforced layer is joined face to face with one or several additional simultaneously supplied layers by means of joining equipment. This makes it possible to manufacture multilayered semi-finished products in a production line without having to store the obliquely reinforced layer that is being continuously supplied.

According to an appropriate further improvement of the invention, the additional continuously supplied layers comprise another obliquely reinforced layer, in which case the fiber orientation of the obliquely reinforced layer is preferably different from the additional obliquely reinforced layer. A higher flexing strength can be achieved in the finished machined part by using several layers. Tensile strength in various directions of the finished machined part can also be achieved when the various obliquely reinforced layers have different fiber orientations.

According to an appropriate further improvement of the invention, the additional continuously supplied layers comprise a longitudinally reinforced layer that is continuously supplied by a device for the uninterrupted supply of a longitudinally reinforced layer. By using several layers, a higher flexing strength can be achieved in the finished machined part. When the obliquely reinforced layer is combined with a longitudinally oblique layer, tensile strength in various directions of the finished machined part can also be achieved.

According to an appropriate further improvement of the invention, the hose is turned around its longitudinal axis during step d). In this case, the endless cut can be generated with a fixed cutting unit and the semi-finished product can be pulled out of the cutting device in one single plane. This facilitates both a possibly intended winding of the semi-finished product and a possibly intended joining of the obliquely reinforced layer with additional continuously supplied layers.

Furthermore, the invention refers to a device for executing a method—especially according to one of the preceding claims—to manufacture a continuous semi-finished product for producing machined parts, in which case the semi-finished product has at least one obliquely reinforced layer that has a polymer matrix and reinforcing fibers embedded therein, in which case the reinforcing fibers of the at least one obliquely reinforced layer run obliquely to the longitudinal direction of the semi-finished product.

The device according to the invention provides the following components for continuously manufacturing the at least one obliquely reinforced layer:
a feeding device for supplying a large number of reinforcing fibers in longitudinal direction to a hose former, in which case the hose former has been developed like a hose in such a way that the reinforcing fibers fed into it run in the longitudinal direction of the hose,
a solidification machine for solidifying the hose containing the reinforcing fibers in its circumferential direction in a way to stabilize the hose's form, and
a hose-cutting machine for cutting up the hose containing the reinforcing fibers in such a way that at least one endless cut can be generated obliquely to the circumferential direction of the hose so the obliquely reinforced layer is created.

The device according to the invention makes an efficient implementation of the method according to the invention possible.

Developments and further developments of the equipment according to the invention are explained in the description of the method being claimed.

In this context, the developments and further developments of the invention explained above and/or repeated in the subclaims can:
except in cases of clear dependencies or incompatible alternatives, for example, be used individually or also combined in any way with one another.

The invention and its advantageous developments and further developments as well as their advantages are explained in more detail by means of drawings, each of them showing in a schematic basic sketch:

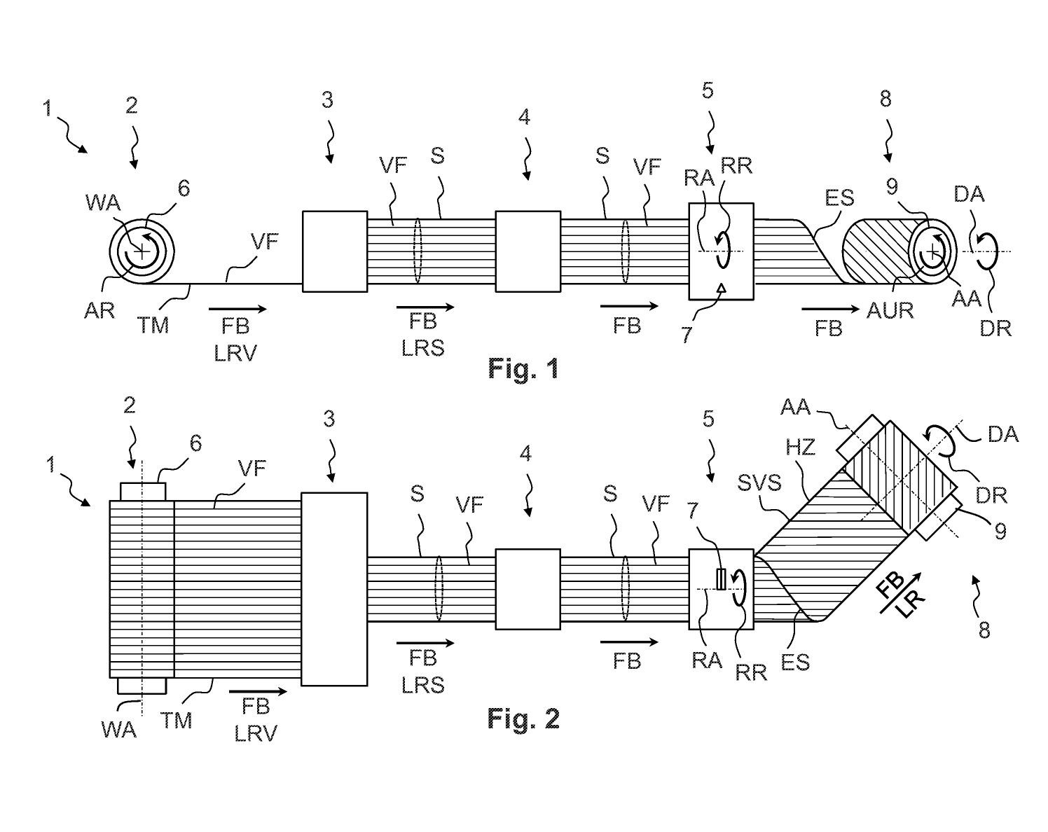

FIG. 1 a schematic side view of a first embodiment of a device according to the invention,

FIG. 2 a schematic top view of the device of FIG. 1 according to the invention,

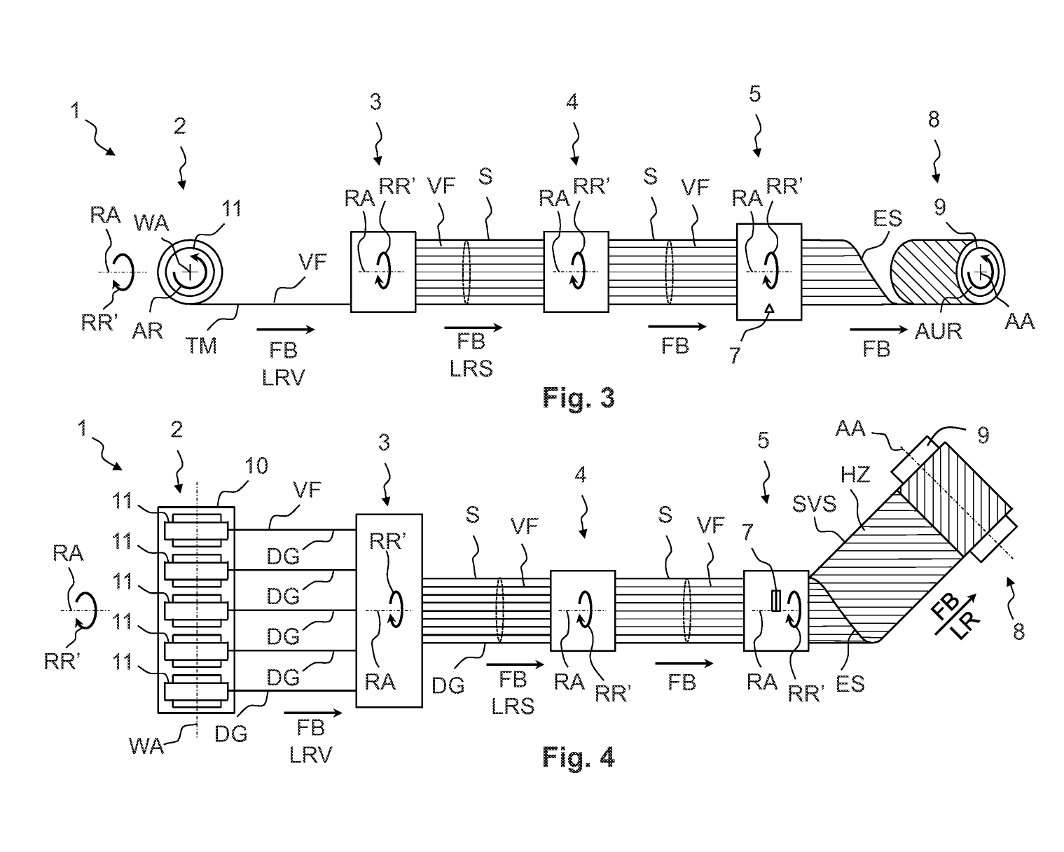

FIG. 3 a schematic side view of a second embodiment of a device according to the invention,

FIG. 4 a schematic top view of the device of FIG. 3 according to the invention,

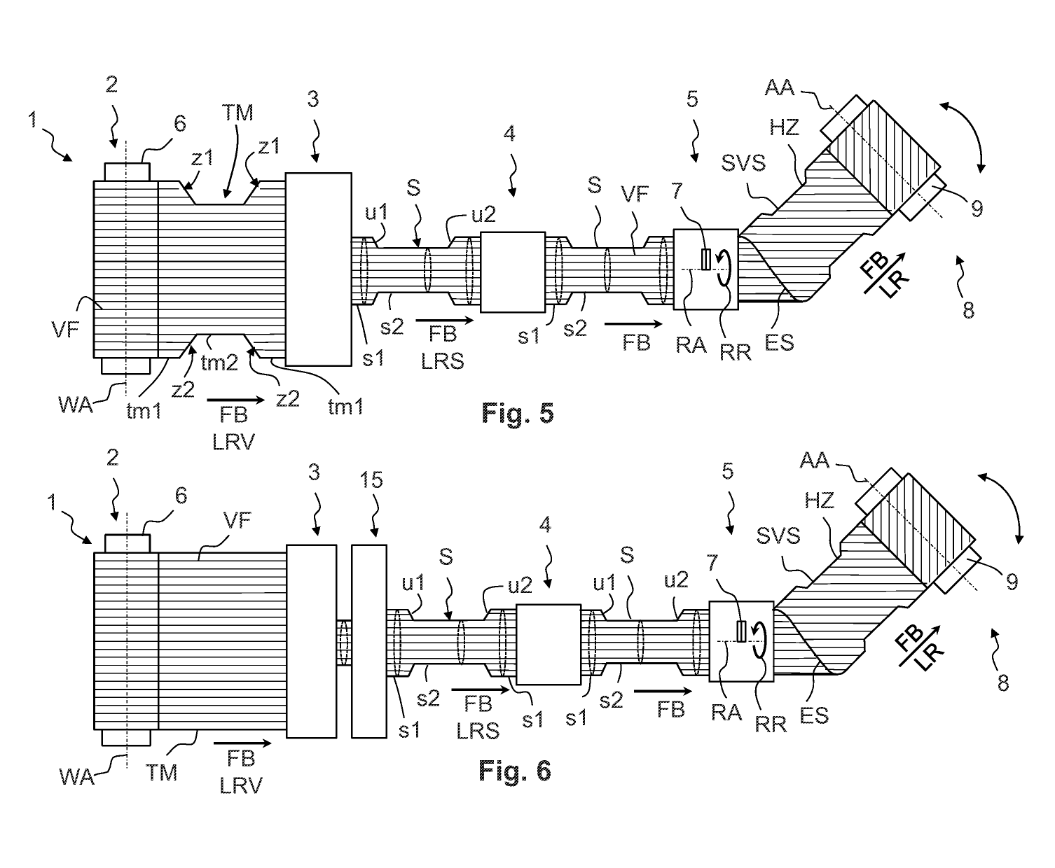

FIG. 5 a schematic top view of a third embodiment of a device according to the invention,

FIG. 6 a schematic top view of a fourth embodiment of a device according to the invention.

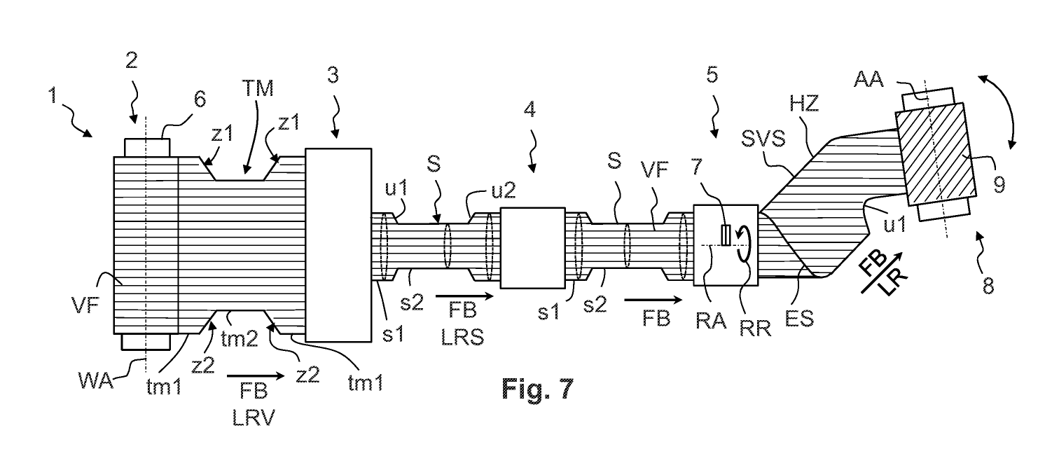

FIG. 7 the third embodiment with a schematic representation of the semi-finished product geometry obtained by means of a cut through a transition area between two different hose diameters,

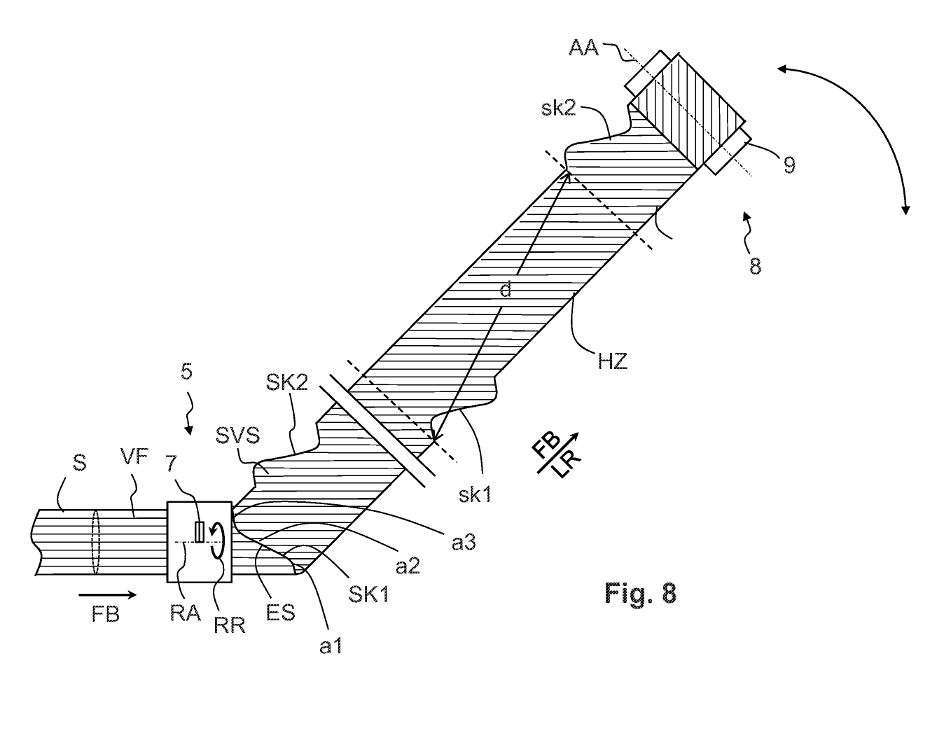

FIG. 8 a schematic (sectional) top view of the fifth embodiment of a device according to the invention, and

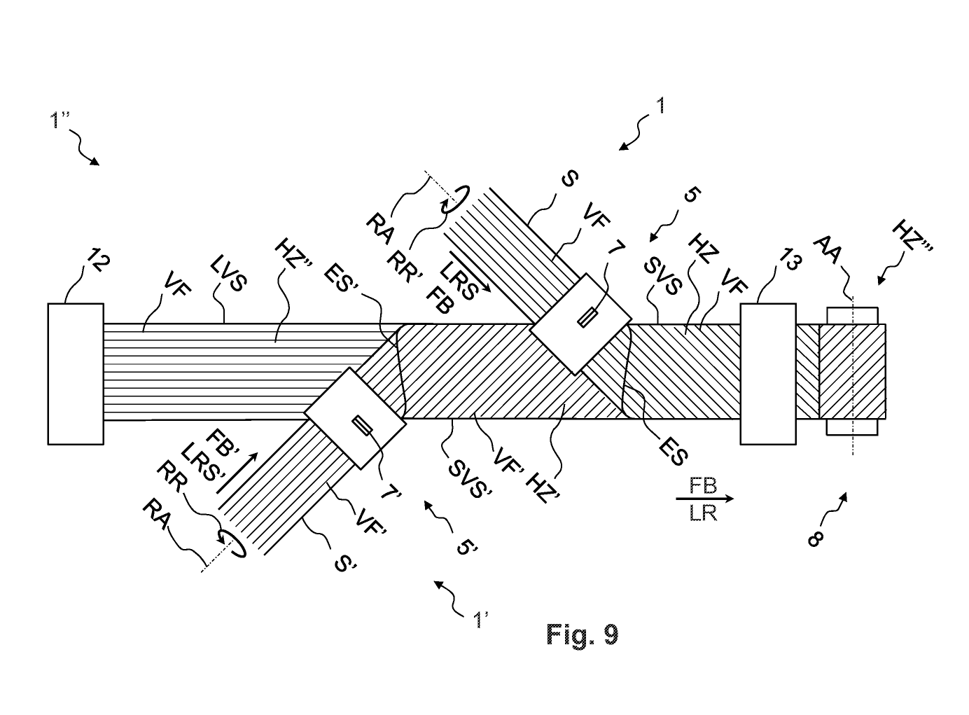

FIG. 9 a schematic top view of a sixth embodiment device according to the invention.

In the following figures, parts corresponding to one another are given the same reference signs. In them, only those components of a device necessary for understanding the invention are given reference signs and explained. It is self-evident that the device according to the invention can have more parts and structural groups.

FIGS. 1 and 2 show a schematic side view and a schematic top view of a first embodiment of a device 1 according to the invention for implementing a method to manufacture a continuous semi-finished product HZ for making machined parts, in which case the semi-finished product HZ has at least one obliquely reinforced layer SVS that has one polymer matrix with reinforcing fibers VF embedded therein, in which case the reinforcing fibers VF of the at least one obliquely reinforced layer SVS run obliquely to the longitudinal direction LR of the semi-finished product HZ.

The device 1 according to the invention for the continuous manufacturing of the at least one obliquely reinforced layer SVS has the following components: A feeding device 2 for supplying a large number of reinforced fibers VF in their longitudinal direction LRV to a hose former 3, in which case the hose former 3 is configured to form the supplied reinforcing fibers VF to become a hose S (in the figures, the tubular form is hinted at with broken lines for clarification purposes) in such a way that the reinforcing fibers VF run in longitudinal direction LRS of the hose S, a solidification machine 4 for solidifying the hose S containing reinforcing fibers VF in its circumferential direction in such a way that the form of the hose S is stabilized, and a hose-cutting machine 5 for cutting up the hose S containing the reinforcing fibers VF in such a way that at least one endless cut ES can be generated obliquely to the circumferential direction of the hose S, so that the obliquely reinforced layer SVS is created continuously.

In step a), the feeding device 2 guides a large number of reinforcing fibers VF in theft longitudinal direction LRV to the hose former 3. Here, the feeding device 2 can supply many reinforcing fibers VF in their longitudinal direction LRV in endless form. To achieve this, it can be equipped with passive mechanical fiber-handling aids such as combs, eyelets, guiding channels and the like, as well as active mechanical fiber-handling aids such as carrier rollers, shafts and the like, and/or pneumatic fiber-handling aids such as suction devices, blowing devices and the like (not shown).

In step b), the reinforcing fibers VF supplied are shaped to a hose S by means of the hose former 3, so that the reinforcing fibers VF run in longitudinal direction LRS of the hose S. Here, a hose S is understood to be a hollow cylindrical arrangement of the reinforcing fibers VF. The hose S preferably has a circular cross section because an especially uniform density of the reinforcing fibers VF can be achieved in circumferential direction. To do this, the hose former 3 can also be equipped with passive mechanical handling aids such as eyelets, guiding channels and the like, active mechanical handling aids such as carrier rollers, shafts and the like, and/or pneumatic handling aids such as suction devices, blowing devices and the like (not shown).

The hose S is advanced with known (and therefore not shown) carrier systems. For example, transportation can be accomplished by belts that engage on the inner side of the hose and can be arranged especially in the hose former 3. Several such belt drives can be provided in sections displaced in tubular direction. Alternatively or additionally, known hose pulling-off systems can also be used.

In step c), the hose S containing reinforcing fibers VF in its circumferential direction is solidified with a solidification machine 4, thus stabilizing the form of the hose S. Here, carrier and/or pull-off systems are used for advancing the hose effectively.

Solidification takes place in such a way that the stabilized hose S containing the reinforcing fibers VF can be cut with the hose-cutting machine 5 in one step d) so that at least one endless cut ES is generated obliquely to the circumferential direction of the hose S, so that the obliquely reinforced layer SVS can be supplied continuously. Here, obliquely to the circumferential direction means that the cut ES takes place under an angle unequal to zero compared to the circumferential direction. In this case, the endless cut ES can be made by mechanical cutting, a laser, a liquid jet (e.g. a water jet or air jet or using another method). Here, in the embodiment shown in FIGS. 1 & 2, the endless cut ES is made with a rotating cutting unit 7—in terms of the hose 5, in circumferential direction in a rotation direction RR—around a rotation axis RA, in which case a helical cut is the result of the superposition of the rotational movement of the cutting device 7 and the continuous movement FB of the hose S in its longitudinal direction LRS. As a result of this, an continuous layer of semi-finished product HZ is produced in which the reinforcing layers VF run obliquely to the longitudinal direction LR of the semi-finished product HZ. The angle under which the reinforcing fibers VF run with respect to the longitudinal direction LR of the layer SVS comes about from the angle of inclination of the helical cut ES. The following applies here: The smaller the angle of inclination, the larger will be the angle under which the reinforcing fibers VF run with regard to the longitudinal direction LRS of layer SVS.

The method according to the invention and the device according to the invention make possible the continuous manufacturing of an endless semi-finished product HZ with an obliquely reinforced layer SVS characterized by homogenous distribution and a parallel alignment of the reinforcing fibers VF. In this case, high working speed is possible because no components that need to move back and forth (execute a changing movement) are necessary.

According to the embodiment shown in FIGS. 1 & 2, the obliquely reinforced layer SVS is wound up with a winding machine 8 following step d) so the semi-finished product HZ can be easily stored and transported. The winding machine 8 has a winding roller 9 rotating around a winding axis AA in a winding machine AUR in order to wind up the obliquely reinforced layer SVS. To prevent a twisting of the obliquely reinforced layer SVS, the winding roller 9 additionally rotates in rotational direction DR around a rotational axis DA, which is oriented obliquely to the winding axis AA. Here, the winding roller 9 rotates with the same angular speed as the cutting unit 7.

In the embodiment of FIGS. 1 & 2, the supplied reinforcing fibers VF are fed in form of at least one longitudinally reinforced flat textile material TM. Here, a longitudinally reinforced flat textile material TM is understood to be an object having reinforcing fibers VF that run in the longitudinal direction of the object and are joined transversally to one another by means of the polymer matrix. The feeding device 2 comprises a winding roller 6, which rotates around a winding axis WA in a winding direction AR in order to supply the flat textile material TM with the reinforcing fibers VF continuously. In this case, the hose S can be formed in such a way that the flat textile material TM is folded on one of two sides, so that the lateral edges of the flat textile material TM are joined together. In this case, the solidification of the hose S can be limited to the area of the edges that were joined together. To obtain uniform wall strength in the hose 5, both edges can be joined together without overlapping and joined together in step C). However, it is also conceivable for the edges of the flat textile material TM to be thinner than in a middle area. Here, an overlapping of the edges can be provided to facilitate the joining of the edges in step c). For example, the edges can be joined through straddling and doubling (i.e. putting them on top of one another).

Steps a), b), c) and d) are advantageously executed in a continuous movement FB of the moved reinforcing fibers. This means that the reinforcing fibers VF are guided continuously without breaks from one step to another while the method is being implemented. In this process, the motion speed of the reinforcing fibers in each one of steps a), b), c), d) reaches at least the same value in order to prevent an undesired pile-up of material or delay of the reinforcing fibers VF. This method prevents costly interim storage of the reinforcing fibers VF and the semi-finished product HZ can be manufactured with high speed.

According to a preferred further improvement of the invention, the solidification in step c) is done by gluing the reinforcing fibers VF, fusing the reinforcing fibers VF, wetting the reinforcing fibers VF, gassing the reinforcing fibers VF, sewing the reinforcing fibers VF together and/or applying a (preferably textile) reinforcing layer.

Gluing can be done through cold bonding, in which the adhesive produces a form-fitting adhesive bond between the reinforcing fibers VF, and/or through hot bonding, in which an adhesive is heated and produces a form-fitting adhesive bond between the reinforcing fibers when it cools off.

As far as the reinforcing fibers VF are suitable for welding, solidification can also take place through welding, in which case the reinforcing fibers VF are heated up at least partially until the limit of liquefaction and become firmly bonded to one another as they solidify.

Solidification can also be achieved by wetting the reinforcing fibers VF by applying a liquid on the reinforcing fibers VF. For example, it is possible to liquefy (at least partially) an avivage adhering to the reinforcing fibers VF using a suitable liquid so that when the avivage (livening) is subsequently dried, the result is a bond between the reinforcing fibers VF.

Furthermore, solidification can be accomplished by gasifying the reinforcing fibers VF, in that a suitable gas is applied on the reinforcing fibers VF. Thus, it is also possible, using a suitable gas, to liquefy (at least partially) an avivage adhering to the reinforcing fibers VF, to create a bond between the reinforcing fibers VF during the subsequent solidification of the avivage.

Solidification can also be accomplished through sewing together, which means that the reinforcing fibers VF are held together by a thread.

Apart from that, solidification can also be done by applying a reinforcing layer, especially a textile one.

Preferably, the supplied reinforcing fibers VF comprise glass fibers, carbon fibers and/or aramid fibers. Such materials meet the requirements made to reinforcing fibers VF, particularly regarding their toughness; they are also economical and can be easily processed. However, other high module fibers are also possible,

In an embodiment of the invention, the reinforcing fibers VF being fed include twisted staple fibers. Machined parts that contain reinforcing fibers VF in form of twisted staple fibers have higher strength transversally to the main direction of the reinforcing fibers VF than those machined parts made with reinforcing fibers in form of continuous fibers, also known as filaments. In particular, the holding together of the individual layers can be improved in machined parts that have several layers.

Additionally, hybrid yarns with staple fibers have relatively less hollow space than hybrid yarns with continuous fibers, which lowers the risk of undesired entrapped air when the machined part is being formed (i.e. during the consolidation of the textile surface fabric). The strength of the machined part is improved in this way.

Furthermore, semi-finished products HZ made of staple fibers can be more easily draped than their pendants made of filaments, thus facilitating the wrinkle-free insertion of the textile surface fabric into the form tool. At the same time, this lowers the risk of damaging the structure of the semi-finished product HZ. This method not only lowers the form tool's manufacturing costs but also allows the production of complex shaped machined parts from semi-finished products HZ because the latter can then be better laid against the contour of the form tool.

Furthermore, the use of staple fibers lowers the risk of buckling the fibers during further processing, especially during draping. This, in turn, is advantageous for the strength of the subsequent machined part.

In another embodiment of the invention, the reinforcing fibers VF that are being fed include continuous fibers. Machined parts that contain reinforcing fibers VF in form of continuous fibers are stronger longitudinally to the main direction of the reinforcing fibers VF than those machined parts produced with reinforcing fibers VF in form of twisted staple fibers. If the reinforcing fibers VF are now arranged in such a way that their longitudinal direction LRV corresponds (at least sections thereof) to a main direction of stress of the subsequent machined part, then this machined part will be able to withstand mechanical stresses better. In this way, the ratio of mechanical strength to weight of the machined part can be improved.

In an embodiment of the invention, the reinforcing fibers VF being fed are deeply mixed with thermoplastic matrix fibers or covered with them to obtain a layer SVS of a semi-finished product HZ that contains both the reinforcing fibers VF and the polymer matrix in form of thermoplastic matrix fibers. This results in a simplification of the process because the polymer matrix does not have to be inserted later. The subsequent manufacturing of the machined part can then take place easily in that the semi-finished product HZ is heated in a mold machine until the thermoplastic matrix fibers melt, so that the semi-finished product HZ can be fitted exactly to the mold machine and the semi-finished product HZ solidifies when cooling off, thus creating the finished machined part.

Here, a deep mixing of various kinds of fibers means a mixture in which there is largely a homogeneous mixture at the level of the individual fibers. This means that the various kinds of fibers are mixed so thoroughly that groupings of purely identical fibers essentially no longer occur. The use of deep mixtures or reinforcing fibers VF covered by thermoplastic matrix fibers ensures the thorough mixing of the thermoplastic matrix fibers and the reinforcing fibers VF in the semi-finished product HZ. In this way, it is possible to achieve the full wetting of the reinforcing fibers VF when the thermoplastic matrix fibers are melted on, so that in the subsequent machined part the interactions between the thermoplastic matrix and the reinforcing fibers VF are maximized by an improved bond and the result is a machined part capable of withstanding high mechanical stressed while simultaneously having low weight.

The thermoplastic matrix fibers include preferably polyurethane fibers (especially fibers made of PU), polyamide fibers (especially fibers made of PA), polyetherketone fibers (especially fibers made of PAEK) and from their derivatives, particularly PEEK, PEK, PEEEK, PEEKEK, & PEKK), polypropylene fibers (especially fibers made of PP), acrylonitrile-butadien-styrene fibers (especially fibers made of ABS) and/or polyester fibers (especially fibers made of PES and their derivatives, especially PBT, PC, PET, & PEN). Such materials fulfill, in particular, the requirements regarding their strength, are economical and can be easily processed.

FIGS. 3 and 4 show a second embodiment of a device 1 according to the invention for implementing a method for manufacturing a continuous semi-finished product HZ to produce machined parts. Only the differences with respect to the first embodiment are explained below. Unless not expressly ruled out, all characteristics of the first embodiment can be provided in the second embodiment.

In the second embodiment, the reinforcing fibers VF in form of discrete yarns DG are fed. To do this, the feeding device 2 has a bobbin creel 10 that can have many delivery bobbins 11. Although the reinforcing fibers VF are solidified on the entire perimeter of the hose S in step c), uneven spots in the area of the edges that were joined together of a hose S made from a flat textile material TM are prevented and this improves the uniformity of the polymer matrix and/or the reinforcing fibers VF in the subsequent semi-finished product HZ.

Furthermore, in the second embodiment, the hose S is rotated around its longitudinal axis RA during step d). In this case, the endless cut ES with a fixed cutting unit 7 can be done and the semi-finished product HZ can be pulled off from the hose-cutting machine 5 in one plane, thereby facilitating both a possibly intended winding of the semi-finished product because the winding roller 9 must now only rotate around the winding axis AA and a possibly intended joining of the obliquely reinforced layer with additional continuously supplied layers.

In order to rotate the hose in step d), the feeding device 2, the hose former 3, the solidification machine 4 and the hose-cutting machine 5 (except the cutting unit 7) must in each case rotate around a rotation axis RA in one rotation direction RR′.

FIGS. 5-7 show various embodiments for manufacturing an endless semi-finished product with variable width for making machined parts. In particular, all features of the previous embodiments can be provided in these embodiments, unless not expressly ruled out.

In the third embodiment shown in top view in FIG. 5, a polymer matrix with the reinforcing fibers VF embedded therein (which together constitute the longitudinally reinforced flat textile material TM) is fed to the hose former 3 in said longitudinal direction and various widths. According to the merely schematic representation shown in FIG. 5, the flat textile material TM is supplied in form of successive sections tm1 and tm2 having different widths. The textile material TM with this geometry being fed to the hose former 3 is shaped to a hose S with sections s1 and s2 that have correspondingly different hose diameters—preferably always with an overlapping of the edges of the polymer matrix or textile material TM in the same way in the hose's circumferential direction. The forming of the hose creates transition areas u1 and u2 between hose sections s1 and s2.

The variable-width textile material TM, created here by the polymer matrix and the reinforcing fibers VF embedded therein, can preferably be made by the temporary supply of edge-sided additional webs z1 and z2 (see FIG. 5)—likewise preferably consisting of polymer matrix and reinforcing fibers VF—to a textile web having constant width. The last-mentioned central textile material web with constant width, which is continuously being supplied, defines the minimum width of the textile material being fed to the hose former 3 capable of being enlarged by supplying the additional webs z1 and z2 from one or both sides. The additional webs z1 and z2 are supplied here with a cut of approx. 45° in order to allow continuous hose formation. FIG. 5 shows textile material section tm2, whereas additional textile material in form of additional webs z1 and z2 is being temporarily supplied (e.g. with interruptions) from both sides in section tm1. The only temporarily supplied additional web sections z1 and z2, which can be drawn off by additional creels, for example (not shown here), can be joined with the textile material web of constant width in an additional step not shown here before being supplied together to the hose former 3.

Instead of a textile material TM formed by a polymer matrix with embedded reinforcing fibers VF, the reinforcing fibers VF (including those for the additional webs z1 and z2) can also be supplied in form of discrete yarns DG (see above). Then, for example, for the described width variance of the semi-finished product, additional discrete yarns DG of defined length can then be drawn off from one or both sides or edges, for example, from additional bobbin creels and supplied to the continuous (and central) reinforcing fibers.

Alternatively to a temporary supply of additional webs z1 and z2, notches can be provided in the transitions tm1 to tm2 and tm2 to tm1 transversally to direction FB, which have already been done and are available in the textile material TM to be wound up by the feeding device 2 or inserted into a cutting device (not shown) arranged before the hose former 3. As a result of this, edge-sided cuts of the textile material can be made in order to produce width variations of the textile material TM before it is fed to the hose former 3.

FIG. 5 shows schematically how the configuration of the textile material TM being fed to the hose former 3 comes out of it as a hose and then also the solidification machine with the same geometry, i.e. likewise as hose S with the different sections s1 and s2. The slanted cutting up in the hose-cutting machine 5 supplied the resulting semi-finished product shown only in a very schematic way in FIG. 5 with a width variance in its longitudinal direction LR. The width variance will in reality look different from what FIG. 5 shows (and also FIG. 6, see below). Here, it should only become clear that the semi-finished product can be produced with a variable width. The exact course and an offset of the narrower area that is shown in the longitudinal direction LR of the semi-finished product HZ are not reproduced here.

The most varied geometries or width variations of the textile material TM fed to the hose former 3 can be achieved in the above-mentioned embodiment. Thus, convex or concave width variations can be created merely on one edge side of the textile material TM, while the other edge side runs linearly towards FB. Straight cuts or curved edges are possible, likewise contours running offset towards one another in both borders with parallel courses not towards FB.

According to the fourth embodiment shown in FIG. 6, a textile material TM with uniform width is fed to the hose former 3, which manufactures a hose S with uniform diameter, whereby different sections of this hose S are variously expanded from the inside in a subsequent, well-known inflating device 15. FIG. 6 indicates that there is a bigger expansion in sections s1 than in section s2 lying in between. Altogether, it is possible to obtain hose geometry similar to the exemplary geometry of the third embodiment, for example (cf. FIGS. 5 & 6). Additionally or alternatively, a negative pressure device can be provided with which the diameter of the hose S can be reduced compared to its normal diameter (the reference sign 15 indicates this in FIG. 6). The solidification of the hose S with the different diameters takes place afterwards in the solidification machine 4. The endless cut ES, in turn, creates a semi-finished product HZ with variable width. As already explained in FIG. 5, the form of the semi-finished product HZ is shown only in a highly schematic way. For example, in the cut made through the transition areas u1 and u2, an asymmetrical course of the semi-finished product HZ is obtained in reality, but not shown here.

The right section of FIG. 7 shows what kind of curve could result in a cut made through the transition area u1. The bent course of the semi-finished product HZ shown here in a highly schematic representation that gives only a rough idea—from one cut made through the transition area u1 of a tubular section s1 with larger hose diameter (results in a wider section of the semi-finished product HZ) to a tubular section s2 with smaller hose diameter (results in a narrower section of the semi-finished product HZ). Because this bending results in a change of direction of the semi-finished product HZ to be wound up, the winding roller 9 is arranged so it can be displaced, preferably swiveled and this is symbolized by the double arrow (this double arrow is likewise correspondingly drawn in FIGS. 5 & 6 to symbolize that a swiveling of the winding roller 9 can also be provided).

In the section according to FIG. 8, another embodiment for making a semi-finished product HZ with variable width in its running direction LR is shown. Here, a hose S with constant diameter is cut up in the hose-cutting machine not with a constant angle of inclination, but with varying angles of inclination, so that a semi-finished product HZ with width variance is obtained.

The top view of the detailed view of FIG. 8 shows merely the hose-cutting machine, into which a hose S with constant diameter is being fed, and the winding machine 8. Here a curved cut ES has been made whose angle of inclination is relatively large at first in a downstream section a1, then flattens out in a section a2, and starts increasing again in a third section a3. The edge cut corresponding (only roughly) to this cut ES and the still unwound up cut edge SK1 opposite the cut edge SK2 of the already unwound semi-finished product are also shown in FIG. 8,

Further downstream from the hose-cutting machine 5 it is indicated how the two cut edges sk1 and sk2 (represented with broken lines) that resulted from a cut ES corresponding to FIG. 8 (the cuts made before or after are not considered here) behave spatially towards one another in the running direction LR of the semi-finished product HZ due to the unwinding. It is especially obvious that the two cut edges sk1 and sk2 have are separated by a space d in running direction LR.

To simplify things, FIG. 8 does not show that by changing the angle of inclination during the cut, the width of the semi-finished product HZ increases or decreases, resulting in a change of the pull-off angle. If the angle of inclination is increased, for example, a width increase is obtained. Thus, it must also be possible to swivel the winding roller here, as indicated here by the double arrow (cf. FIG. 7).

In the embodiments of FIGS. 5-8, no additional turning of the winding roller 9 in rotational direction DR around a rotational axis DA is provided; such a winding roller 9 can be readily provided, however.

With the help of the embodiments of FIGS. 5-8 it was explained how by adjusting the diameter and the diameter changes as well as the angle of inclination of the cut it is possible to obtain the most varied geometries in the semi-finished product. Needless to say, combinations of the embodiments individually presented above are possible too.

FIG. 9 shows a sixth embodiment of device 1″ according to the invention for implementing a method for manufacturing a continuous semi-finished product HZ to produce machined parts. Only the differences compared to the previous embodiments will be explained below. In particular and as far as not expressly ruled out, all characteristics of the preceding embodiments can be provided in the sixth embodiment.

In the sixth embodiment, after completing step d), the continuously supplied obliquely reinforced layer SVS is joined two-dimensionally with several other simultaneously and continuously supplied layers SVS′, LVS is two-dimensionally joined with a Joining device 13. As a result of this, it is possible to manufacture multilayered semi-finished products HZ′″ in one production line without having to store temporarily the continuously supplied obliquely reinforced layer SVS.

In the sixth embodiment, the other continuously supplied layers SVS′, LVS comprise an additional obliquely reinforced layer SVS′, in which case preferably the fiber orientation of the SVS differs from the fiber orientation of the other obliquely reinforced layer SVS′. By using several layers SVS, SVS′, LVS can achieve a higher flexural strength in the finished machined part. When the various obliquely reinforced layers SVS, SVS′, LVS have different fiber orientations, tensile strength in several directions can additionally be achieved in the finished machined part.

In the sixth embodiment, the other continuously supplied layers SVS′, LVS have a reinforced layer LVS that is continuously being supplied by a device 12 for the continuous supply of a longitudinally reinforced layer. When the obliquely reinforced layer SVS is combined with a longitudinally reinforced layer LVS, tensile strength in several directions can additionally be achieved in the finished machined part.

The device 1″ comprises an initial device 1 (only partially shown), which is explained above by means of FIGS. 3 and 4, and continuously supplies a first obliquely reinforced layer SVS. Furthermore, a second device 1′ is provided (shown only partially) that is built analogously to the first device 1 and supplies a second obliquely reinforced layer SVS′ continuously. In the first device 1, the hose S rotates in rotational direction RR′ and in the second device 1′ in the opposite rotational direction RR. This arrangement causes an angle of +X° in the first obliquely reinforced layer SVS for the alignment of the reinforcing fibers VF and an angle of −X° in the second obliquely reinforced layer SVS′ for the alignment of the reinforcing fibers VF′.

Furthermore, a device 12 for continuously supplying a longitudinally reinforced layer LVS is provided. The devices 1, 1′ and 12 are arranged in such a way that the layers SVS, SVS' and LVS lying close to one another can be supplied with the same speed of a joining device 13. The joining device 13 joins the layers SVS, SVS′ and LVS, so a three-layered semi-finished product HZ″ results.

Instead of an angular or oblique supply of the various semi-finished products HZ, HZ′, HZ″ relative to one another, they can also be joined together on top of one another in order to manufacture a multilayered semi-finished product HZ′″.

### LIST OF REFERENCE SIGNS

1 Device for manufacturing an continuous semi-finished product for producing machined parts
2 Feeding device
3 Hose former
4 Solidification machine
5 Hose-cutting machine
6 Unwinding roller
7 Cutting unit
8 Winding machine
9 Winding roller
10 Bobbin creel
11 Delivery bobbin
12 Device for the continuous supply of a longitudinally reinforced layer
13 Joining device
15 Inflating device and/or negative pressure device
HZ Semi-finished product
SVS Obliquely reinforced layer
VF Reinforcing fibers
LR Longitudinal direction of the semi-finished product
LRV Longitudinal direction of the reinforcing fibers
Hose
LRS Longitudinal direction of the hose
ES Endless cut
TM Longitudinally reinforced flat textile material
AR Unwinding direction
WA Unwinding axis
RR Rotational direction
RA Rotational axis, longitudinal axis
AUR Winding direction
AA Winding axis
DR Rotational direction
DA Rotational axis
FB Continuous movement
DG Discrete yarn
LVS Longitudinally reinforced layer
z1 Additional web
z2 Additional web
tm1 Textile material section
tm2 Textile material section
s1 Tubular section
s2 Tubular section
u1 Transition area
SK1 Cut edge
SK2 Cut edge
sk1 Cut edge
sk2 Cut edge
a1-a3 Sections of the endless cut ES

1. Method for manufacturing a continuous semi-finished product (HZ) to produce machined parts, whereby the semi-finished product (HZ) has at least one obliquely reinforced layer (SVS) that has a polymer matrix and reinforcing fibers (VF) embedded therein, in which case the reinforcing fibers (VS) of the at least one obliquely reinforced layer (SVS) run obliquely to the longitudinal direction (LR) of the semi-finished product (HZ), characterized in that the at least one obliquely reinforced layer (SVS) is continuously manufactured through the following steps:
a) Feeding many reinforcing fibers (VF) in their longitudinal direction (LRF) to a hose former (3) by means of a feeding device (2),
b) Forming the reinforcing fibers (VF) that were fed to become a hose (5) by means of the hose former (3), in such a way that the reinforcing fibers (VF) run in longitudinal direction (LRS) of the hose (S),
c) Solidifying the hose (S) that contains the reinforcing fibers (VF) in its circumferential direction by means of a solidification machine (4), in a way to stabilize the form of the hose (S),
d) Cutting up the stabilized hose (S) containing the reinforcing fibers (VS) with a hose-cutting machine (5), in such a way that at least one endless cut (ES) is generated obliquely to the circumferential direction of the hose (S), so that the obliquely reinforced layer (SVS) is supplied continuously.

2-18. (canceled)
